(19) United States
(12) Patent Application Publication
(10) Pub. No.: US 2016/0162642 A1
(43) Pub. Date: Jun. 9, 2016

(54) Integrated Medical Record System using Hologram Technology

(71) Applicant: William Atkinson, Orlando, FL (US)

(72) Inventor: William Atkinson, Orlando, FL (US)

(21) Appl. No.: 15/018,855

(22) Filed: Feb. 8, 2016

Related U.S. Application Data
(63) Continuation-in-part of application No. 13/676,939, filed on Nov. 14, 2012.

(51) Int. Cl. G06F 19/00; G03H 1/00; G03H 1/08

(52) U.S. Cl. CPC G06F 19/322; G06F 19/327; G06F 19/3487; G03H 1/08; G03H 1/0005; G03H 2001/0061

(57) ABSTRACT

In one aspect of the invention, a computer-implemented method may include maintaining in a computer system, a plurality of relationships among users in an aggregated data network. A user may receive a plurality of data points, where at least one of the data points, was requested via a relationship inquiry, made using a Health Insurance Portability and accountability Act (HIPAA) compliant security clearance user interface. The computer-implemented method may generate a Global Patient Health Record Timeline (GPHRT), comprising a chronological representation of one or more of the received data points, by utilizing their time stamps to correctly order the data points. The computer-implemented method may include an interactive holographic display system, to render the GPHRT as a holographically produced image. The user may be able to manipulate and navigate the holographic image via gestures and haptic feedback.

### RELATED APPLICATIONS

This application is a continuation-in-part of U.S. application Ser. No. 13/676,939, filed Nov. 14, 2012.

The entire teachings of the above application are incorporated herein by reference.

### FIELD OF THE INVENTION

The present invention relates to the field of electronic medical records and, more specifically, to a computer system for requesting medical record data from various databases, displaying said data and enabling a user to manipulate the displayed data.

### BACKGROUND OF THE INVENTION

Medical record documentation is necessary and required to record pertinent facts, findings and observations about an individual's health history, including past and present illnesses, examinations, tests, treatments, and outcomes. The documentation process is a tedious process, the medical record chronologically documents the care of the patient in a comprehensive fashion and is an important element contributing to high quality care.

Health-care providers, such as physicians, create large volumes of patient information during the course of their business at health-care facilities, such as hospitals, clinics, laboratories and medical offices. For example, when a patient visits a physician for the first time, the physician generally creates a patient file including the patient's medical history, current treatments, medications, insurance and other pertinent information. This file generally includes the results of patient visits, including laboratory test results, the physician's diagnosis, medications prescribed and treatments administered. During the course of the patient relationship, the physician supplements the file to update the patient's medical history. When the physician refers a patient for treatment, tests or consultation, the referred physician, hospital, clinic or laboratory typically creates and updates similar files for the patient. These files may also include the patient's billing, payment and scheduling records.

With the improvements of technology, computer systems are utilized for storing medical records which are stored in various file formats and different databases. When a patient visits different medical offices, they sometimes have a different medical record at each office chronicling the patient's history with a particular office. As a result, a patient's medical history can be very fragmented because their entire medical history is not stored in a singular location. The current systems are desynchronized and as a result, they do not have the ability to communicate with each other. This problem is compounded by the fact that different medical offices store the medical records in different file formats. Retrieving a patient's entire medical record is difficult because the medical records need to be harvested from different databases which may store the files in different formats. Additionally, the computer system may not have access to the different databases and may not be compatible with the different formats. This lack of uniformity and access to different databases is a huge problem.

Many hospitals, clinics etcetera may use legacy systems which are purely client-server driven and do not include a cloud or internet component. These systems cannot be accessed from another location offsite. The security technologies that these legacy systems utilize are also outdated. The legacy systems do not utilize encryption technology that is sophisticated enough for current standards. Therefore, these legacy systems are more susceptible to data breaches.

Additionally, when a doctor or health-care professional is able to access the entire medical record, manipulation of the medical record such as navigating through the record, editing the record or viewing the entire record, is not an intuitive process. Health-care professionals lose valuable time being taught how to use a computer system that cannot efficiently enable access and manipulation of a medical record. There exists a need for a system that enables a health-care professional to access an entire medical record. The computer system must be able to retrieve portions of the medical record from different databases when the record is stored in various file formats. The system must also enable the health-care professional to quickly view and manipulate the record efficiently.

### SUMMARY OF THE INVENTION

With the foregoing in mind, the present invention is related to a computer system which may retrieve medical records from different databases where the files may be stored in various formats. The retrieved medical record may then be displayed.

In one aspect of the invention, the computer system may include an Enterprise Resource Planning Electronic Medical Records Software Environment (ERP/EMRSE), which may interconnect a Network Aggregate Database Repository with a web-based repository server, security interface, customer resource management platform (CRM), practice management platform (PM), external social network engine and an e-commerce interface. The Network Aggregate Database Repository may be configured to function as a clearing house to clear, transform and catalogue data points. The web-based repository server may provide storage for medical records and the security interface may be configured to provide Health Insurance Portability and Accountability Act (HIPAA) compliant security features. The CRM and PM platform may be configured to organize, automate, and synchronize medical practices and business processes and the external social network engine may be configured to enable sharing of patient approved medical information on social media directly from the computer system.

The e-commerce interface may facilitate payments and the Network Aggregate Database Repository may interface with the e-commerce interface to efficiently route and catalog processed payments. The computer system may be configured to maintain a plurality of relationships among users in an Aggregated Data Network that may interface with an Electronic Medical Record (EMR) system, Health Information Exchange (HIE) system, Personal Health Record (PHR) system, Picture Archiving and Communication System (PACS), Hospital Information Systems (HIS), Laboratory Information Systems (LIS), Assigned Health-care Providers, user health insurance plans, medical and dental providers and medical devices of at least one user.

In one embodiment of the invention, each relationship may include a connection between at least two users of the Aggregated Data Network and the computer system may be configured to receive for at least one relationship, data points from the Aggregated Data Network. The data points may include one or more clinical encounter data points, medical history data points, clinical history outcomes, profile data and clinical relationship details from at least one user in the relationship. Each one of the received data points may include a time stamp which may indicate a time of occurrence; and at least one of the data points may be received via a relationship inquiry made using a HIPAA compliant security clearance user interface, which may require secure patient authorization, to grant access to all of the received data points, to one or more users of a Global Patient Health Record Timeline (GPHRT).

The computer system may be configured to generate a GPHRT which may include a chronological representation of one or more of the received data points by utilizing their time stamps to correctly order the data points and an interactive holographic display system may be configured to render the GPHRT as a holographically produced image.

The interactive holographic display system may include a microphone, one or more front facing cameras, one or more motion sensors and may respond to gesture control. The interactive holographic display system may also be configured to respond to haptic feedback control. The interactive holographic display system may further include a voice and speech recognition module that responds to voice commands.

In one embodiment, the computer system may be configured so that an end user may be able to utilize haptic feedback control to navigate one or more holographic images of a displayed medical record. An end user may also be able to populate data fields of the holographically produced image by utilizing speech recognition and entering the recognized speech into the data fields of a displayed medical record.

The computer system may also be configured so that the voice and speech recognition module may be able to translate the end user's voice from one language into another language within the holographically produced image. The voice and speech recognition module may also be able to identify possible recognized speech elements for repeated spoken instances of a speech element within the holographically produced image and produce a speech recognition result by selecting a recognized speech element from the holographically produced image. In a further embodiment of the current invention, the voice and speech recognition module may utilize a markov model to recognize the speech elements.

Another embodiment of the invention may include a computer-implemented method for retrieving one or more medical records and holographically displaying the one or more retrieved medical records using a computer system, an Aggregated Data Network and an interactive holographic display system. The method may include maintaining in the computer system a plurality of relationships among users in the Aggregated Data Network that interfaces with an Electronic Medical Record (EMR) system, Health Information Exchange (HIE) system, Personal Health Record (PHR) system, Picture Archiving and Communication System (PACS), Hospital Information Systems (HIS), Laboratory Information Systems (LIS), Assigned Health-care Providers, user health insurance plans, medical and dental providers and medical devices of at least one user. Each relationship may include a connection between at least two users of the Aggregated Data Network. Data points from the Aggregated Data Network may be received for at least one relationship, where the data points may include one or more clinical encounter data points, medical history data points, clinical history outcomes, profile data and clinical relationship details from at least one user in the relationship. Each one of the received data points may include a time stamp which indicates a time of occurrence and at least one of the data points may be received via a relationship inquiry made using a Health Insurance Portability and Accountability Act (HIPAA) compliant security clearance user interface, which may require secure patient authorization, to grant access to all the received data points, to one or more users of a Global Patient Health Record Timeline (GPHRT). The computer-implemented method may further include generating a GPHRT which may include a chronological representation of one or more of the received data points by utilizing their time stamps to correctly order the data points, and utilizing an interactive holographic display system to render the GPHRT as a holographically produced image.

The details of one or more embodiments of the invention are set forth in the accompanying drawings and the description below. Other features, objects and advantages of the invention will be apparent from the description and drawings, and from the claims.

### BRIEF DESCRIPTION OF THE DRAWINGS

FIG. 1 is a diagram illustrating an Aggregated Data Network of the current invention.

FIG. 2 is a diagram illustrating an Enterprise Resource Planning/Electronic Medical Record Software Environment of the current invention.

FIG. 3 is a diagram of an Interactive Holographic Display System.

FIG. 4 is a flow diagram of an exemplary process for generating a Global Patient Health Record Timeline.

FIG. 5 is a diagram illustrating a metadata module of the current invention.

FIG. 6 is a flow diagram of an exemplary process for generating a narrative.

FIG. 7 is an illustration of a data entry screen for entering patient information of the current invention.

FIG. 8 is an illustration of a user using a hologram of the current invention.

FIG. 9 is an illustration of a user navigating among holographically displayed images of the current invention.

FIG. 10 is an alternate view of FIG. 9 from above.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

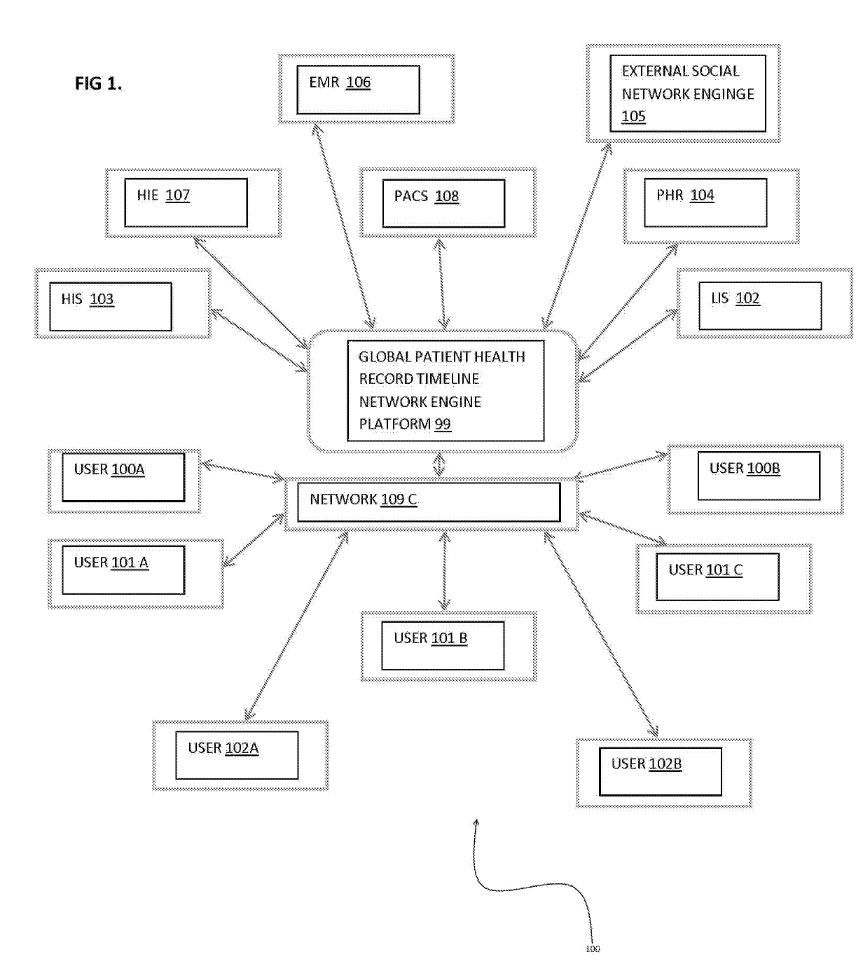

Referring to the figures, FIG. 1 illustrates an embodiment of the Aggregated Data Network (ADN) 100. The ADN 100 was referred to as a social networking system in the parent/incorporated application. The ADN 100 may enable retrieving medical records from various databases to create a complete medical history for a patient and generating a holographic image of the patient's medical timeline from the medical history. ADN 100 may provide aggregation of data shared across disparate health-care technologies by enabling communication over different platforms and databases that may be incompatible with each other. The ADN 100 may be a system where doctors can communicate with doctors and patients and patients can communicate with doctors or other patients if necessary.

A user or a plurality of users (100A, 100B, 101A, 101B, 101C, 102A, 102B) may be able to access the Global Patient Health Record Timeline (GPHRT) Network Engine Platform 99 and the following various databases: Laboratory Information Systems (LIS) 102, Hospital Information Systems (HIS) 103, Personal Health Record (PHR) 104, Electronic Medical Record (EMR) 106, Health Information Exchange (HIE) 107 and the Picture Archiving and Communications System (PACS) 108 through the network 109C of ADN 100. The various databases connected to ADN 100 may be connected through the network, and may be cloud based and/or hard-wired to the system. One of ordinary skill in the art would know that this list of databases is not an exhaustive list and that a practitioner may vary the number or type of databases without departing from the scope of the invention.

ADN 100 may enable a user or a plurality of users (100A, 100B, 101A, 101B, 1010, 102A, 102B) to access databases that are not compatible with each other. The ADN 100 may enable cross platform communication so that a user may be able to communicate with different databases. For example, user 100A may be able to utilize HIS 103 and also communicate with one or more databases, such as PHR 104 and/or PACS 108.

The ability to access databases that are not ordinarily compatible with each other is advantageous, because it makes the record retrieval process more efficient, and a user would not have to utilize multiple systems to retrieve medical records for a patient. A user may be a health-care provider that typically has access to and control of a plurality of external health-care record data sources. A health-care provider may be without limitation, a doctor, nurse, physician, nursing assistant, physician's assistant, lab technician or the like. A user may also be a health-care entity for example, without limitation a hospital, or a clinic, a doctor's office etcetera.

An embodiment of the invention may also include legacy databases. Legacy databases are older databases that utilize technology that may be outdated or no longer current as compared to the standards of modern day. These legacy databases may also be connected to the network 109C so that a user or a plurality of users (100A, 100B, 101A, 101B, 1010, 102A, 1028) may be able to access the legacy databases to retrieve and store medical records.

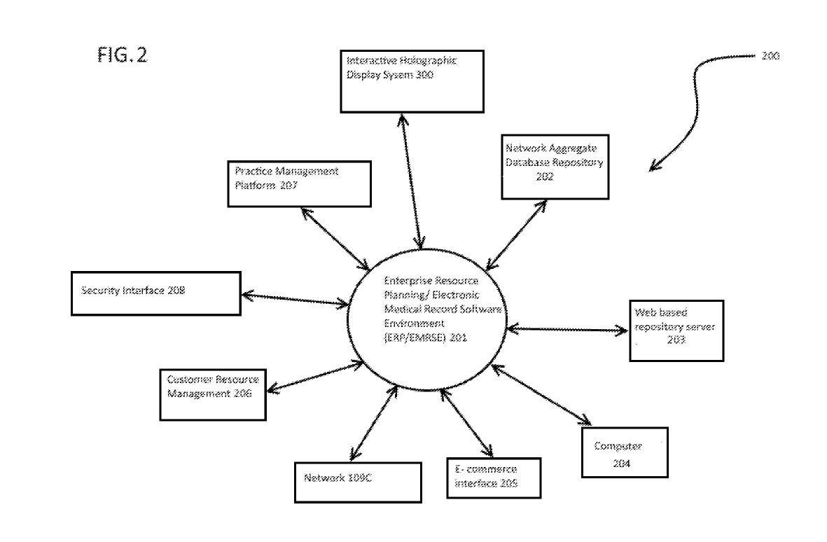

A user or a plurality of users (100A, 100B, 101A, 101B, 1010, 102A, 102B) may log onto the system using a computer 204 (displayed in FIG. 2). Logging onto the system may entail the verification of a user name and a password to ensure that the user attempting to log onto the system has the appropriate access. A verified user or plurality of users (100A, 100B, 101A, 101B, 1010, 102A, 102B) may be given a particular level of access and assigned a set of privileges that are relevant to their access level. A privilege may authorize a user or plurality of users (100A, 100B, 101A, 101B, 1010, 102A, 102B) to perform a specific action. For example, if a user 100A does not have the privilege to read accounts, any attempt by that user to read an account will fail.

The system may use additional security features to verify that a user, for example, user 100A, has adequate authority to use the system. These security features may include, without limitation, verification of biometric data such as a facial scan, retina scan, voice identification, and/or a fingerprint system. One with ordinary skill in the art would appreciate that the security features required to log into a system may be altered or changed without departing from the scope of the invention. A computer may be defined as, without limitation a laptop, desktop or a mobile device such as a cellular phone, a tablet, a phablet and the like. One of ordinary skill in the art will appreciate that one or more web enabled devices may be used to log on to the system without departing from the scope of the invention.

When the user 100A successfully logs into the system (for brevity, user 100A is utilized as an example, however one or more users described above may use the system as will be described in a similar fashion), the user 100A may be able to retrieve the medical records for one or more patients or beneficial users 109A. The user 100A may be able to view, edit, add or delete clinical data, patient's GPHRT, patient records, lab and test values and treatment data. User 100A may also be able to view, edit, add and delete medical images such as but not limited to x-rays, magnetic resonance images (MRIs), sonograms, computed tomography scans and the like. The clinical data, patient records, lab and test values, treatment data and medical images etcetera may be collectively referred to as medical records.

User 100A may utilize the ADN 100 to maintain a plurality of relationships among other users such as 100B, 101A, 101B, 101C, 102A, and 102B for example. The ADN 100 may interface with an LIS 102, HIS 103, PHR 104, EMR 106, HIE 107 and PACS 108. ADN 100 may also interface with assigned health-care providers, user health insurance plans, medical and dental providers and medical devices of at least one user. One of ordinary skill in the art will recognize that the number of users that can form relationships may be changed or altered, without departing from the scope of the invention.

User 100A may identify one or more other users associated with the GPHRT Network Engine Platform 99, External Social Network Engine 105, and the Network 1090, such as users 1010, 101B, and 102B, with which user 100A may want to create and maintain a relationship with, so that user 100A may share, distribute or receive approved medical data which is related to the patient 109A. User 100A may also want to alter the details of an existing relationship or import supporting medical information from a plurality of databases such as but not limited to LIS 102, HIS 103, PHR 104, EMR 106, HIE 107 and PACS 108, Assigned Health-care Providers, user health insurance plans, medical and dental providers, medical devices and a plurality of other external health (or medical) record data storage source points, that are related to the patient 109A. The medical devices may include, but are not limited to, connected devices such as a Magnetic Resonance Imaging device, an X-Ray device or a blood pressure, glucometer and the like.

The medical record, plan of treatment, existing contraindications, and medical history of the patient 109A and other related medical information may be shared with other medical providers. In FIG. 1, these other health-care providers may be represented by users such as 1010, 101B and 102B. In an embodiment of the invention, patient 109A may have to provide authorization before any additional user or health-care entity may be allowed to use the medical information of the patient. The approval by patient 109A may occur in a manner that is compliant with current government Health Insurance Portability and Accountability Act (HIPAA) mandates.

Each relationship that is created and maintained by user 100A may include a connection between at least two users of the ADN 100. For example, a relationship may include a connection between user 100A and user 100B. In another example, user 100A may also set up a plurality of relationships with a plurality of users as determined by the type of access granted to the other users (100B, 101A, 101B, 1010, 102A, 102B) by user 100A or the medical situation that pertains to patient 109A.

User 100A may be able to receive, for at least one relationship, data points from the ADN 100, where the data points may include one or more clinical encounter data points, medical history data points, clinical history outcomes, profile data and clinical relationship details from at least one user in the relationship. The received data points may include time stamps that correspond to a time of occurrence for a given clinical event.

Clinical encounter data points may be directly related to the patient 109A. Clinical encounter data points may include information such as allergies, contraindications to medications, past inpatient and outpatient procedures and may generally refer to the direct delivery of care to the actual patient. Medical history data points may relate to the history of the family related to the patient. The medical history points may indicate if family members of the patient 109A have a history of diseases or sicknesses. For example, the medical history points may indicate that the father of patient 109A suffers from high blood pressure, or diabetes. This type of historical family information has proven useful in treating and delivering adequate care to patients. Clinical history outcomes may report the actual outcome of the treatment. The outcome reported may indicate the success or failure of a particular course of treatment and any other noteworthy events when applying the treatment. For example, the outcome may report that the use of a particular medication was a success or the results of a surgical operation. The clinical history outcome may include side effects experienced by patient 109A and/or information relating to the patient's experience with the treatment. Profile data may include information such as but not limited to, patient demographic data, gender, ethnicity, address, height, weight, blood type, known afflictions, allergies and the like. The clinical relationship may detail the doctor-patient relationship.

The data points that may be received, may be received by a relationship inquiry made using a HIPAA compliant security clearance user interface. The user 100A may require secure patient authorization to be granted access to all of the received data points. The data points may be received by the GPHRT Network Engine Platform 99 and may be used to generate a Global Patient Health Record Timeline. The GPHRT Network Engine Platform 99 is responsible for organizing the data points for presenting to user 100A. The data points may be arranged in a chronological manner to generate the GPHRT. Alternatively, a user may determine how the data points may be arranged to generate the GPHRT. The timeline generated may include the entire medical history of patient 109A or a redacted history depending on user 100A's access level. The user 100A may also arrange the generated timeline to only show particular sections of patient 109A's timeline. For example, user 100A may only require dental records or medical entries related to a particular section of patient 109A's body such as their heart or liver. In another instance, user 100A may also tailor the timeline generated by a date range or treatment by a particular doctor or group of doctors. Alternatively, the system itself may suggest related medical entries that the user 100A may find relevant based upon the selection(s) of the user 100A, or the sections of the medical history of the patient 109A that are typically selected.

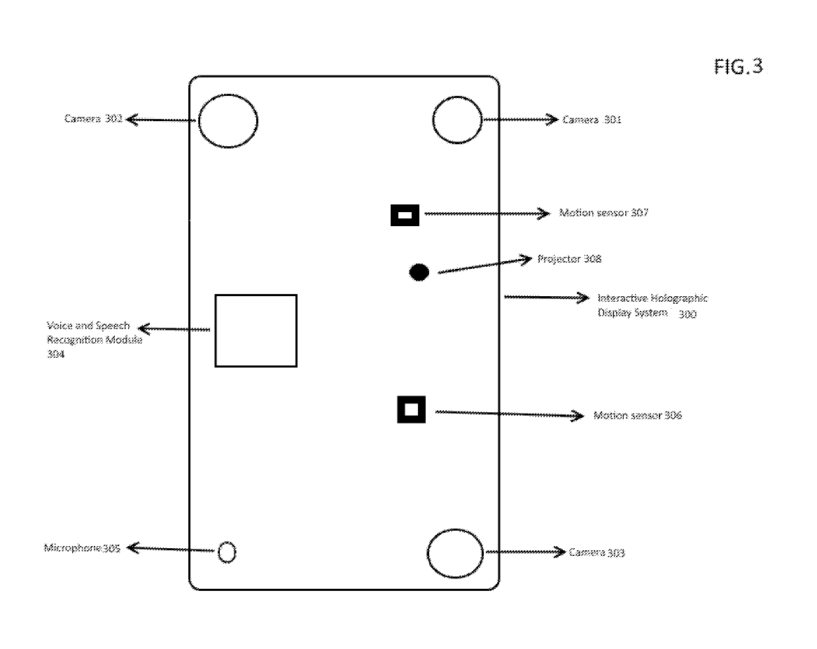

The data points for generating the GPHRT may be fed into an interactive holographic display system (IHDS) 300 (displayed in FIG. 3). The IHDS 300 may receive the data points and may project an image which displays the GPHRT holographically.

User 100A may utilize the GPHRT Network Engine Platform 99 and External Social Network Engine 105 via Network 109C. User 100A may enter details about a health-care provider, clinical relationship, medical records, plan of treatment and other data applicable and related to treatment of the patient 109A. The GPHRT Network Engine Platform 99 and External Social Networking Engine 105 may then send the data comprising the details from user 100A to other users or medical providers, (for example, 101A, 102A, and 100B) that are approved to access the GPHRT of the patient 109A, by the initial grant of access to all subsequent users and or providers that are related to the beneficial user's 109A current medical care, or have been involved in their care in the past. Upon receiving the data from user 100A, the other users of the system such as 101A, 102A and 100B may provide input in response to the data that is presented. The response may, for example, modify or delete the existing data or enter new data.

The External Social Network Engine 105 may be configured to enable sharing of medical information on social media directly from the computer system. The External Social Network Engine 105 may enable user 100A and or the patient 109A to share non HIPAA protected medical information at the click of a button. Therefore the non HIPAA protected medical information may be shared on social media such as, without limitation, Facebook, Instagram or Twitter. In a separate embodiment, patient 109A may provide HIPAA compliant authorization so that desired medical information may be posted on a social network.

FIG. 2 also displays an embodiment of a system of the invention. In FIG. 2, 200 displays the Enterprise Resource Planning/Electronic Medical Record Software Environment (ERP/EMRSE) 201 and the various connections to said ERP/EMRSE 201. ERP/EMRSE 201 may interconnect the Network Aggregate Database Repository (NADR) 202 with a web-based repository server 203, customer resource management platform (CRM) 206, practice management platform (PMP) 207, security interface 208, external social network engine (displayed in FIG. 1 as 105) and an e-commerce interface 205 and an Interactive Holographic Display System (IHDS) 300.

A user 100A may use the computer 204 to interact with NADR 202. NADR 202 may be utilized to function as a clearing house to clear, transform and catalogue data points. The NADR 202 takes the data points from all the different sources and creates the GPHRT. The NADR 202 may essentially function as the back-end that organizes the data points into a Global Patient Health Record Timeline. The GPHRT Network Engine Platform 99 may essentially function as the front-end and take the organized data points and generate the GPHRT for presentation. In an embodiment of this invention, as explained earlier, the GPHRT may be fed into IHDS 300 for display. In a separate embodiment, the GPHRT may be displayed on a computer screen, monitor or projected etc so that user 100A may see the GPHRT. In the event that the GPHRT is not displayed holographically, user 100A may be allowed to interact with the GPHRT via touch, use of a keyboard, mouse or other devices used for input into a computer as known to a person of ordinary skill in the art. The data points may be made available for use by other users within the ERP/EMRSE 201 total environment, or localized medical data ecosystem for data mining, online analytical processing, and a plurality of various other synchronized functions.

Procedures and various diagnoses may be entered using International Statistical Classification of Diseases and Related Health Problems (ICD) codes and/or Current Procedural Terminology (CPT) codes. User 100A, who may be entering the payment information may have to enter the CPT and/or ICD codes which may identify a procedure, treatment and/or diagnosis for a patient 109. The ERP/EMRSE 201 may include medical revenue cycle management. The medical revenue cycle management may enable the billing for a particular CPT and/or ICD code(s) to be sent to a clearing house which processes these codes, and sends a bill to the correct entity, such as but not limited to, an insurance carrier or the patient 109.

E-commerce interface 205 may facilitate payments and interface with NADR 202 to efficiently route and catalog various processed payment orders that have been made by patient 109A. Although one computer is displayed in FIG. 2, a person of regular skill in the art would understand that the one or more computers may be utilized with the described system without departing from the scope of the invention.

The web-based repository 205 may be web-based or cloud based and may provide additional storage for medical records utilized to create the GPHRT, or store information the user 100A may need to retrieve later, during the diagnosis and treatment of the patient 109A.

The CRM 206 and PMP 207 may be used to organize, automate, and synchronize medical practice and business process activities, such as invoicing of patients, patient procedure time block data mining for patient schedule flow management and back office marketing information. The CRM 206 and PMP 207 may be further used for report generation related to the medical revenue cycle management of a health-care entity. For example, if a primary care provider wants to know his return on investment (ROI) for a direct mailer campaign he implemented a year ago and compare it to past direct mail campaigns, the provider may run a series of reports directly from the CRM 206 and PMP 207. The reports may be customized to provide a comparative marketing demographic ROI for all zip codes within a 20 mile radius of the primary care practice location. The primary care provider, may run a report through the CRM 206 and PMP 207 platform, within the ERP/EMRSE 201 localized medical data ecosystem, and get analysis and results with procedure breakdown, third party medical insurance reimbursement, provider production as well as collection numbers, and patient copayments during these quarters. The final generated report may help the primary care provider and his staff to reproduce the successful results of their most successful quarters and also improve on those successful results through a variety and plurality of financial reports generated from the CRM 206 within the ERP/EMRSE 201 localized medical data ecosystem.

Security interface 208 may be configured to provide HIPAA compliant security features. Therefore, the minimum standard of security that may be regulated or required by the government may be implemented by the security interface 208. This may be the minimum standard that is required when a system is utilizing, storing and processing personal health information. The standard protects the integrity of the personal health information of patient 109A and/or access to that information. The security interface 208 may ensure that there is no unauthorized access of medical records or a breach of the security of the medical records. One of ordinary skill in the art may refer to a medical record as personal health information, without intending a different interpretation to these terms that are used interchangeably.

FIG. 3 displays an embodiment of the system of the current invention, which also includes an interactive holographic display system (IHDS) 300. The interactive holographic display system is known in the art and will only be briefly described in this application. The IHDS 300 may include one or more front facing cameras and one or more motion sensors. In the IHDS illustrated, IHDS 300 includes 3 cameras (301-303), a voice and speech recognition module (VSRM) 304 and a microphone 305, and motion sensors 306-307. IDHS 300 may also include a projector 308 that is responsible for projecting the hologram. A person of ordinary skill in the art would understand that the elements of IHDS 300 may be varied without departing from the scope of the invention.

IHDS 300 may be used to project holographic images of the generated medical timelines of a patient 109A. IHDS 300 may utilize one or more front facing cameras (301-303) and one or more motion sensors 306-307 to monitor the hand movements and gestures of a user 100A and enable the navigation of the displayed images. IHDS 300 may facilitate gesture control of the displayed holographic images where user 100A may control the manipulation of the images by the motions and movements of their hands. In a separate embodiment, user 100A may wear a specially designed glove or other special equipment that enables IDHS 300 to easily detect the movements of the user 100A's hands to manipulate one or more displayed holographic images. One of ordinary skill in the art would define manipulation to include actions such as (without limitation) resizing, zooming in and out, and rotating the displayed images or highlighting a particular section of the image. In an alternative embodiment of the current invention, a user may use their hands, eyes or any other body part to manipulate the holographic images.

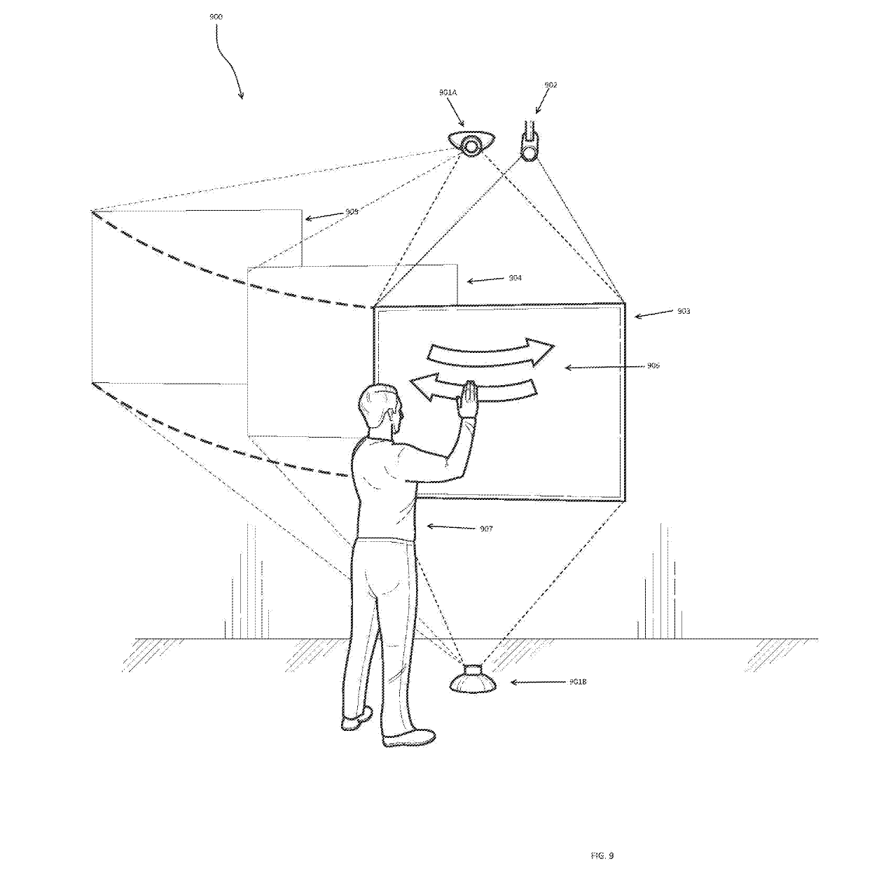

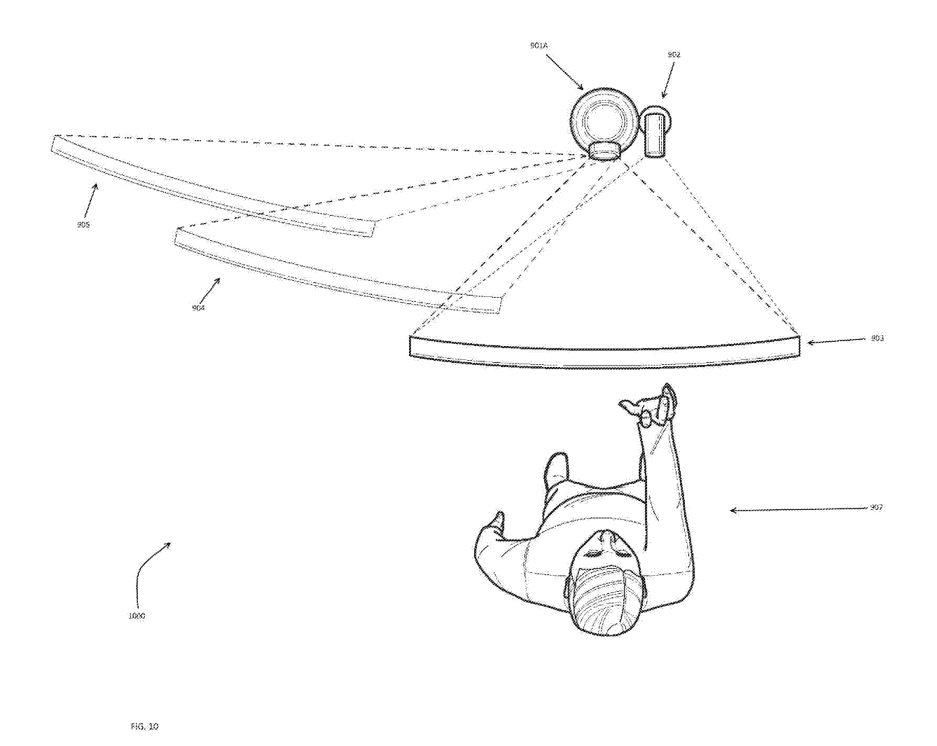

IHDS 300 may also enable haptic feedback control where user 100A may utilize a tactile interface so that the hand movements of the user 100A may be detected by the system. Haptics enables a user to interact with holographic images by the use of touch. Utilizing haptics with a hologram enables a user to interact with the holographic image where a user may move or navigate from one displayed image to another displayed image (as shown in FIGS. 9 and 10 which will be discussed later). Haptic control may also be used to navigate one or more holographic images of a displayed medical record. A user may interact with the holographic image using a glove, stylus and the like. The tactile interface may be integrated into the computer 204 (illustrated in FIG. 2). In an alternative embodiment of the current invention, the tactile interface may be separately connected to the system. The tactile interface is able to detect the movements of the user 100A's hands and translate those motions into commands for navigating one or more displayed holographic images. As a result, user 100A may be able to navigate among one or more displayed holographic images.

IHDS 300 may also a include a microphone 305 which may be utilized to receive verbal information to connect, control, interact, etc. with the IHDS 300 via voice commands. For example, a user 100A use a command such as “save file” or “open file” to cause a save file or open file operation to occur. The VSRM 304 may be utilized to convert speech into program commands to allow a user 100A to interact with IHDS 300 and manipulate one or more displayed holographic images. VSRM 304 may also enable user 100A to populate fields in a holographically displayed medical record by utilizing speech recognition to recognize spoken speech elements and entering those elements to populate data fields of a medical record. For example, a user may be able to dictate entries for the data fields of a medical record such as, but not limited to, the name of a patient and relevant symptoms or a diagnosis and an embodiment of the system is able to recognize the speech and enter the speech into the relevant fields. In a separate embodiment, the user may have to indicate the field when dictating the information so that the system may determine where to enter the recognized speech. In another embodiment of the system, the VSRM 304 may be able to translate the end user's voice from one language into another language within the holographically produced image. For example, user 100A may speak in Spanish and the VSRM 304 may recognize the speech and enter the English equivalent of the recognized speech into the medical record of patient 109A. Additionally, when the user 100A dictates the medical record entries, VSRM 304 may keep a recording of the user 100A so that another user may listen to the dictated medical record entry. VSRM 304 may also playback the voice entry of user 100A in another language if requested.

VSRM 304 may also be able to identify possible recognized speech elements for repeated spoken instances of a speech element within the holographically produced image, and produce a speech recognition result by selecting a recognized speech element from the holographically produced image. For example, user 100A may tell the system to display holographic images from the medical record that pertain to a particular hospital or illness. Additionally, the IHDS 300 may utilize a Markov model with VSRM 304 to recognize speech elements received by the microphone 305.

Markov model theory is well known in the art and may be utilized in statistics and probability. A Markov model is a stochastic model and may be used to model randomly changing systems where it is assumed that future states depend only on the present state and not on the sequence of events that preceded it.

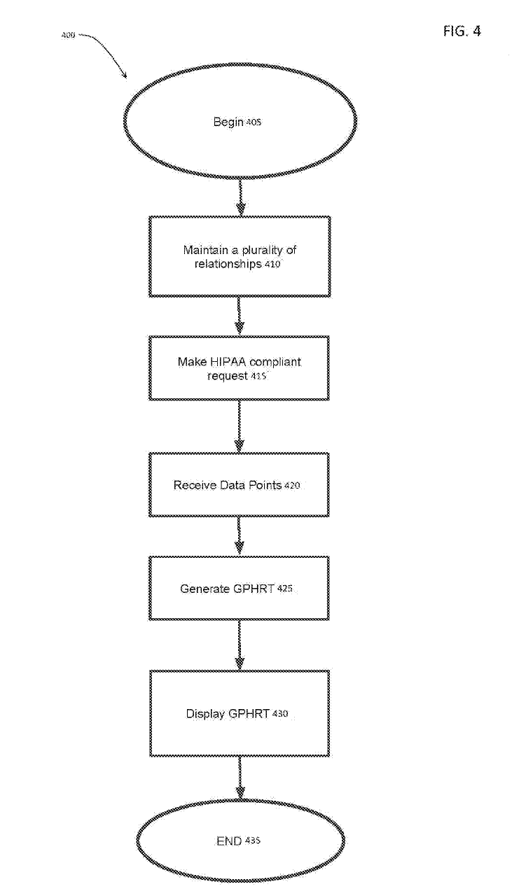

Referring now to flowchart 400 of FIG. 4, a method of retrieving one or more medical records and holographically displaying the one or more retrieved medical records will now be described. Beginning at Block 405, user 100A may be able to maintain a plurality of relationships among users in the ADN 100 at Block 410.

ADN 100 may interface with various databases such as but not limited to, an Electronic Medical Record (EMR) system 106, LIS 102, HIS 103, PHR 104, EMR 106, HIE 107 and PACS 108, Assigned Health-care Providers, user health insurance plans, medical and dental providers and medical devices of at least one user. Each relationship may comprise a connection between at least two users of ADN 100.

User 100A may be enabled to make an HIPAA compliant request at Block 415. An individual's right to access his or her protected health information (PHI) is a critical aspect of the Privacy Rule, of the HIPAA. The Privacy Rule's right of access belongs primarily to the individual who is the subject of the PHI, the Privacy Rule also generally requires that persons who are legally authorized to act on behalf of the individual regarding health-care matters be granted the same right of access. The ability to make an HIPAA compliant request is very significant, given the type and sensitivity of the information involved.

At Block 420, user 100A may receive the data points where the data points may include one or more clinical encounter data points, medical history data points, clinical history outcomes, profile data and clinical relationship details from at least one user in the relationship. The received data points may include time stamps which include a time of occurrence.

At Block 425, the ADN 100 generates the GPHRT. The GPHRT which may be generated may include the entire medical history of patient 109A or a redacted history depending on user 100A's access level. The user 100A may also arrange the generated timeline to only show particular sections of patient 109A's timeline. For example, user 100A may only require dental records or medical entries related to a particular section of patient 109A's body such as their heart or liver. In another instance, user 100A may also tailor the timeline generated by a date range or treatment by a particular doctor or group of doctors. Alternatively, the method itself may suggest related medical entries that the user 100A may find relevant based upon the selection(s) of the user 100A or the sections of the medical history of the patient 109A that are typically selected.

At Block 430, the IHDS 300 may receive the generated GPHRT and display the received GPHRT holographically. IHDS 300 may project one or more holographic images. In an alternative embodiment, the GPHRT may be displayed on a monitor or a computer. The method may end at Block 435.

In the method, IHDS 300 may be used as described earlier to project holographic images of the generated medical timelines of a patient 109A. The holographic images may be projected in chronological order. IHDS 300 may also utilize haptic feedback and monitor the hand movements and gestures of a user 100A to enable the navigation and manipulation of the displayed images.

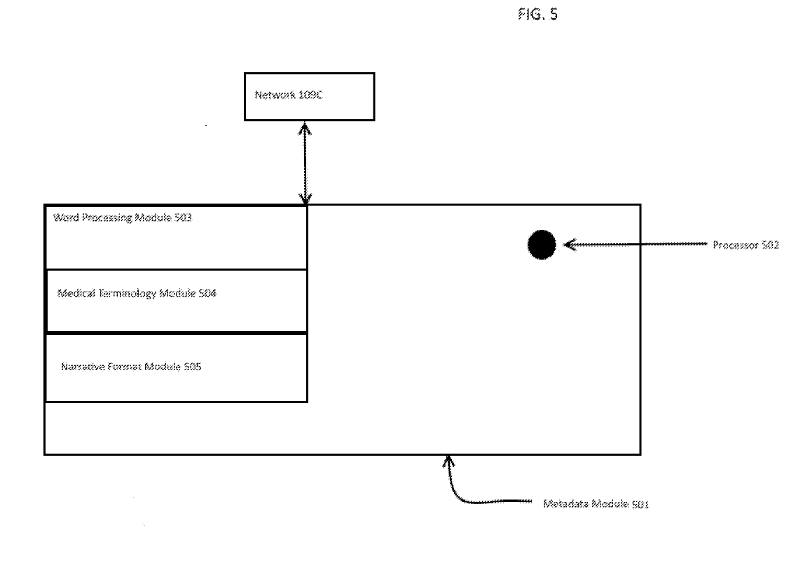

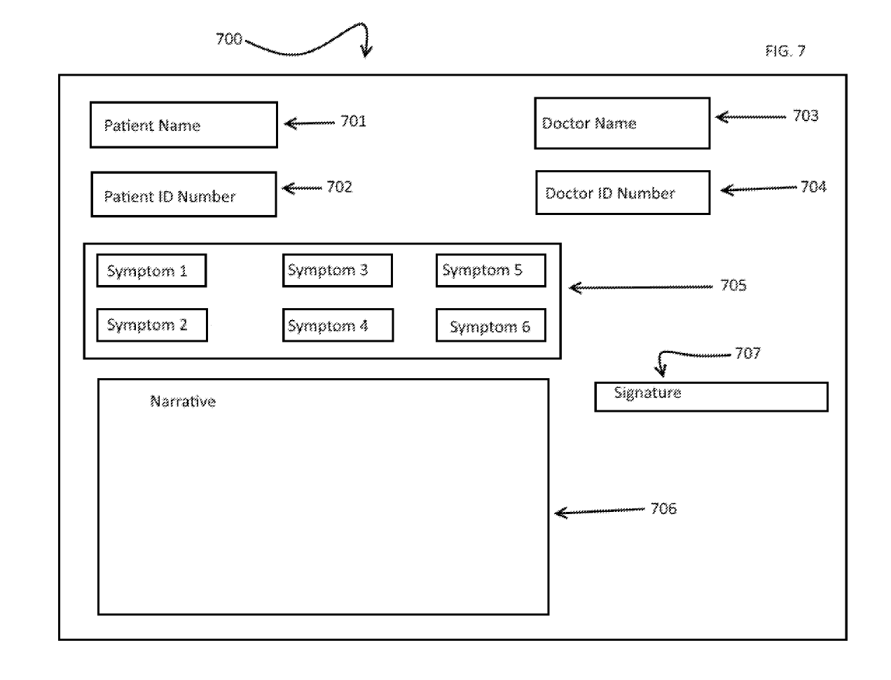

In another embodiment of the invention, illustrated in FIG. 5, the ADN 100 may be connected to a metadata module 501 via network 109C. The metadata module 501 may include a processor 502, a word processing module 503, a medical terminology module 504 and a narrative format module 505. Persons of ordinary skill in the art would note that a metadata module may include multiple processors, word processing modules, medical terminology modules and/or multiple narrative format modules without departing from the scope of the invention. The user 100A may be able to enter data into data fields (described in FIG. 7) which may be stored in web-based repository server 203 (shown in FIG. 2). The data entered by user 100A may include medical data such as, but not limited to blood pressure information, glucose level information, heart rate, symptoms, diagnoses and the like. The metadata module processor 502 may utilize the word processing module 503, the medical terminology module 504 and the narrative format module 505, to process the data entered by a user 100A and produce a medical narrative (sometimes referred to simply as a narrative). The word processing module 503 may read and parse the data fields populated by user 100A. The word processing module 503 may also enable metadata module 501 to generate proper sentences for use in the generated medical narrative. The word processing module 503 may work in concert with the medical terminology module 504 which stores the medical terminology which may be required when describing various health conditions, prognoses and diagnoses. The medical terminology module 504 may include or provide medical terms and phrases that are not normally found in an English dictionary and will serve to provide greater breadth for describing different health scenarios and conditions with increased clarity. The narrative format module 505 may be utilized to generate a narrative for a particular patient. The narrative format module 505 may contain a plurality of different narrative formats, where one particular format is chosen for a particular patient as circumstances may dictate. The type of narrative generated will depend on the patient history, the patient's symptoms, current condition, diagnosis, prognosis and prescribed treatment, A narrative may be considered a concise report that may be generated from the various information input by a user 100A about a patient 109 which may provide a snapshot of the patient 109. This snapshot may or may not include patient 109's history, current diagnosis, prognosis, symptoms, and measurements for the patient 109's vital signs such as but not limited to body temperature, pulse rate, and respiration rate. The snapshot may also include the medical history of the family of patient 109. The snapshot may also include non vital signs such as blood pressure, and glucose level.

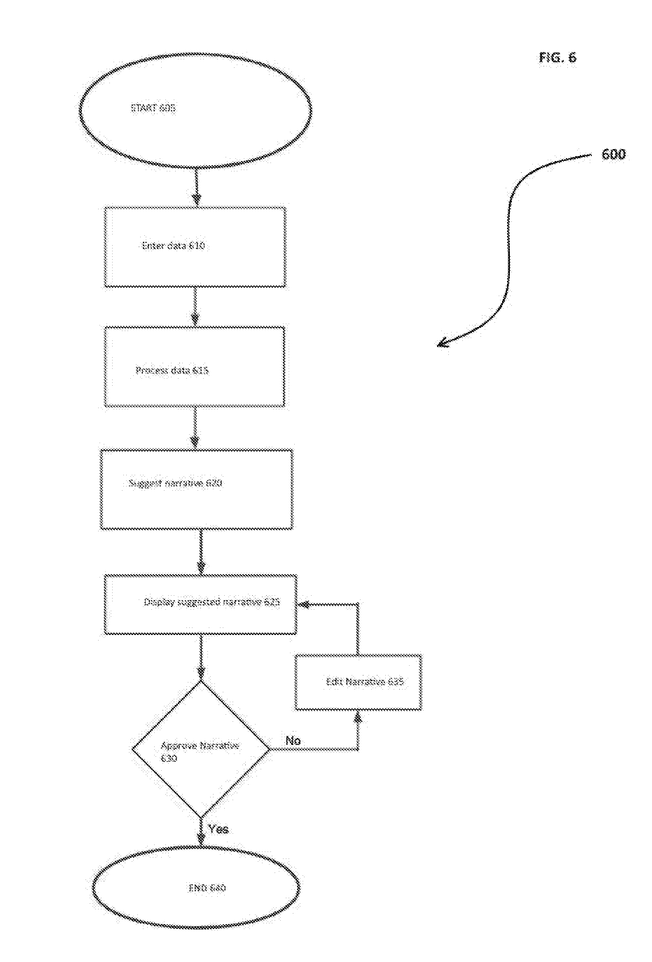

In FIG. 6, another method embodiment of the invention is illustrated. The method begins at block 605 and user 100A may be enabled to enter data at block 610. The data that user 100A may enter may include personal identification information, identification information for patient 109, and medical data (FIG. 7 illustrates some of the data fields that may be utilized user 100A). User 100A may enter the data by dictating the data that needs to be entered into the system. In an alternative embodiment, user 100A may utilize a keyboard that is connected to the system to key in the data. In a further embodiment of the system, a keyboard may be displayed holographically that enables a user to key data into the system. The medical data may be processed at block 615 by the metadata module processor 502 (illustrated in FIG. 5) to generate or suggest the narrative of block 620. The medical data may be processed in relation to a least one particular medical event, where that medical event may be the primary reason for suggesting a particular narrative format. The suggested medical narrative may be automatically generated and may be displayed in block 625. The narrative may be displayed in real time and may respond dynamically to user 100A while information is being entered. In an embodiment of the invention, processing the medical data entered, determining the narrative format and automatically generating the medical narrative all occur in real time.

The narrative may be displayed holographically by the use of IDHS 300. When user 100A has finished entering data, the generated, displayed narrative may be approved by user 100A at block 630. User 100A may opt to edit the narrative at block 635 by changing the text in the narrative to provide a better snapshot of patient 109 than what was automatically generated.

User 100A may approve the narrative by signing the narrative. A narrative is considered authenticated when it is signed. Signing may involve entering the name, signature and/or initials of user 100A. In another embodiment of the invention, user 100A may approve or authenticate the narrative by utilizing a facial scan, retina scan, a fingerprint scan or using biometric data that may uniquely identify user 100A. In an alternative embodiment, user 100A may authenticate the narrative by utilizing haptic control, gesture control or voice commands. After the narrative is approved, the method ends at block 640.

FIG. 7 displays a data entry screen of the current invention. The data entry screen 700 displays an embodiment of the current invention. The data entry screen 700 may be altered or changed without departing from the scope of the invention. The data entry screen 700 may be displayed on a monitor, laptop, mobile device or handset. In an alternative embodiment, the data entry screen 700 may be displayed holographically. The data may be entered in various boxes as indicated in FIG. 7. For example, the patient name and patient ID number may be entered in 701 and 702 respectively. The doctor name and the doctor ID number may be entered in 703 and 704 respectively. The symptoms may be entered for a patient in 705. When user 100A enters the symptoms for the patient 109A, the narrative is dynamically generated and displayed in 706. When the narrative is displayed in 706, user 100A may opt to edit the narrative or authenticate the narrative. The narrative may be authenticated by entering the name or initials or signature of use 100A in 707. Alternatively, as explained above, user 100A may authenticate a narrative using haptic control, gesture control or voice commands.

Utilizing haptic control, user 100A may authenticate the narrative by interacting with the displayed hologram and entering their name, initials and/or signature. Alternatively, user 100A may utilize a gesture with their hands that is recognized so that the narrative may be authenticated. In a further embodiment, user 100A, may authenticate the narrative by using voice commands. The voice commands may be preprogrammed so that the commands are understood. For example, user 100A may say “I approve this narrative” or “narrative approved” or a similar command that is recognized so that the narrative may be authenticated.

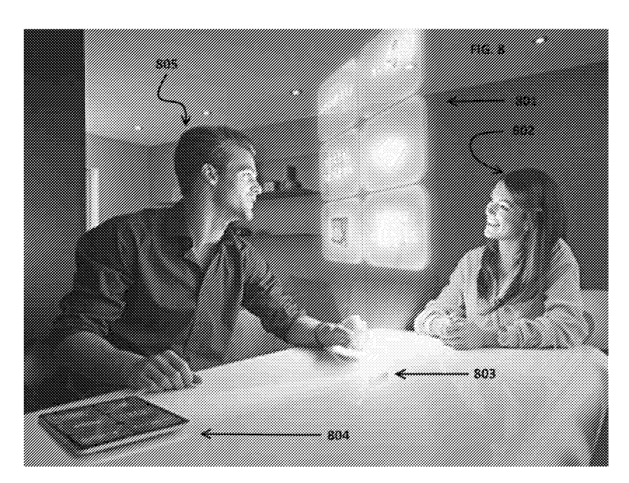

FIG. 8 is an illustration of a hologram as utilized in an embodiment of the current invention. The hologram may be represented by 801 and the patient 109 may be represented by 802. The IDHS 300 may be represented by 803 which projects the hologram upward into the air. In another embodiment of the invention, 803 may be attached to a roof or be located above eye level of a user and project the hologram downward. A further embodiment of the invention may entail utilizing multiple projectors to project a hologram. User 100A, represented here by 805, may utilize 804 (which may represent the computer 204 of FIG. 2) to interact with the system. User 100A may interact with the hologram 801 by utilizing one or more of the following: haptic, gesture and/or voice commands. In another embodiment of the invention, the hologram displayed may be simultaneously displayed on a screen or monitor so that the user 100A may manipulate the hologram from said screen or monitor. Haptic control, as discussed earlier, may enable user 805 to manipulate the contents of the displayed image 801.

FIG. 9 may be an illustration of a user navigating among holographically displayed images, in an embodiment of the current invention. In 900, the hologram 903 may be displayed in front of a user 907. Additional holographic images such as 904 and 905 may also be displayed in the background as an outlined image. In FIG. 9, the outlined images are all to the left of user 907, however if user 907 were to move holographic image 903 to the right, holographic image 904 would be in the center with holographic image 903 on the right of user 907 and holographic image 905 on the left of user 907. A person of ordinary skill in the art would understand that FIG. 9 is only an illustration and multiple outlined holographic images may be displayed. The user 907 may represent user 100A. The hologram 903 may be projected from above with elements 901A and 901B. In a separate embodiment of the invention, a hologram may be displayed by a single projecting element. The arrows 906 may not be displayed. These arrows 906 indicate the gestures that user 907 may use to navigate from one hologram to the other. The gestures of user 907 may be captured by 902 which may function as a camera and a motion sensor. In another embodiment of the invention, 902 may include multiple cameras and multiple motion sensors. FIG. 10 is an alternate view of FIG. 9. where the projector element 901 B is not displayed.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A computer system comprising:
an Enterprise Resource Planning Electronic Medical Records Software Environment (ERP/EMRSE), which interconnects a Network Aggregate Database Repository with a web-based repository server, security interface, customer resource management platform (CRM), practice management platform (PMP), external social network engine and an e-commerce interface;
wherein the Network Aggregate Database Repository is configured to function as a clearing house to clear, transform and catalogue data points;
wherein the web-based repository server provides storage for medical records;
wherein the security interface is configured to provide Health Insurance Portability and Accountability Act (HIPAA) compliant security features;
wherein the CRM and PM platform are configured to organize, automate, and synchronize medical practices and business processes;
wherein the external social network engine is configured to enable sharing of patient approved medical information on social media directly from the computer system;
wherein the e-commerce interface facilitates payments and the Network Aggregate Database Repository interfaces with the e-commerce interface to efficiently route and catalog processed payments;
wherein the computer system is configured to maintain a plurality of relationships among users in an Aggregated Data Network that interfaces with an Electronic Medical Record (EMR) system, Health Information Exchange(HIE) system, Personal Health Record (PHR)system, Picture Archiving and Communication System (PACS), Hospital Information Systems (HIS), Laboratory Information Systems (LIS), Assigned Healthcare Providers, user health insurance plans, medical and dental providers and medical devices of at least one user;
wherein each relationship comprises a connection between at least two users of the Aggregated Data Network; and
wherein the computer system is configured to receive for at least one relationship, data points from the Aggregated Data Network, where the data points include one or more clinical encounter data points, medical history data points, clinical history outcomes, profile data and clinical relationship details from at least one user in the relationship;
wherein each one of the received data points includes a time stamp which indicates a time of occurrence; and
wherein at least one of the data points is received via a relationship inquiry made using a HIPAA compliant security clearance user interface, which requires secure patient authorization, to grant access to all the received data points, to one or more users of a Global Patient Health Record Timeline (GPHRT); and
wherein the computer system is configured to generate a GPHRT comprising a chronological representation of one or more of the received data points by utilizing their time stamps to correctly order the data points; and
wherein an interactive holographic display system is configured to render the GPHRT as a holographically produced image.

2. The computer system of claim 1, wherein the interactive holographic display system includes a microphone, one or more front facing cameras, one or more motion sensors and responds to gesture control.

3. The computer system of claim 2, wherein the interactive holographic display system is configured to respond to haptic feedback control.

4. The computer system of claim 3, wherein the interactive holographic display system includes a voice and speech recognition module that responds to voice commands.

5. The computer system of claim 3, wherein the computer system is configured so that an end user is able to utilize haptic feedback control to navigate one or more holographic images of a displayed medical record.

6. The computer system of claim 4, wherein the computer system is configured so that an end user is able to populate data fields of the holographically produced image by utilizing speech recognition and entering the recognized speech into the data fields of a displayed medical record.

7. The computer system of claim 6, wherein the computer system is configured so that the voice and speech recognition module is able to translate the end user's voice from one language into another language within the holographically produced image.

8. The computer system of claim 6, wherein the voice and speech recognition module is able to identify possible recognized speech elements for repeated spoken instances of a speech element within the holographically produced image and produce a speech recognition result by selecting a recognized speech element from the holographically produced image.

9. The computer system of claim 8, wherein the voice and speech recognition module utilizes a markov model to recognize the speech elements.

10. A computer-implemented method for retrieving one or more medical records and holographically displaying the one or more retrieved medical records using a computer system, an Aggregated Data Network and an interactive holographic display system, the method comprising:
maintaining in the computer system a plurality of relationships among users in the Aggregated Data Network that interfaces with an Electronic Medical Record (EMR) system, Health Information Exchange(HIE) system, Personal Health Record (PHR) system, Picture Archiving and Communication System (PACS), Hospital Information Systems (HIS), Laboratory Information Systems (LIS), Assigned Healthcare Providers, user health insurance plans, medical and dental providers and medical devices of at least one user;
wherein each relationship comprises a connection between at least two users of the Aggregated Data Network; and
receiving for at least one relationship, data points from the Aggregated Data Network, where the data points include one or more clinical encounter data points, medical history data points, clinical history outcomes, profile data and clinical relationship details from at least one user in the relationship;
wherein each one of the received data points includes a time stamp which indicates a time of occurrence; and
wherein at least one of the data points is received via a relationship inquiry made using a Health Insurance Portability and Accountability Act (HIPAA) compliant security clearance user interface, which requires secure patient authorization, to grant access to all the received data points, to one or more users of a Global Patient Health Record Timeline (GPHRT);
generating a GPHRT comprising a chronological representation of one or more of the received data points by utilizing their time stamps to correctly order the data points; and
utilizing an interactive holographic display system to render the GPHRT as a holographically produced image.

11. The method of claim 10, wherein the interactive holographic display system includes a microphone, one or more front facing cameras, one or more motion sensors and responds to gesture control.

12. The method of claim 11, wherein the interactive holographic display system responds to haptic feedback control.

13. The method of claim 12, wherein the interactive holographic display system includes a voice and speech recognition module that responds to voice commands.

14. The method of claim 12, wherein an end user utilizes haptic feedback control to navigate one or more holographic images of a displayed medical record.

15. The method of claim 13, wherein the method utilizes the voice and speech recognition module to enable an end user to populate data fields of the holographically produced image by recognizing spoken speech elements and entering those elements to populate data fields of a medical record.

16. The method of claim 15, wherein the voice and speech recognition module is able to translate the end user's voice from one language into another language within the holographically produced image.

17. The method of claim 15, wherein the voice and speech recognition module is able to identify possible recognized speech elements for repeated spoken instances of a speech element within the holographically produced image and produce a speech recognition result by selecting one or more recognized speech elements from the holographically produced image.

18. The method of claim 10, wherein the Aggregated Data Network further includes a web-based repository server connected to the Aggregated Data Network and so that a user is enabled to enter data into data fields which is stored in said web-based repository server;
wherein the Aggregated Data Network further includes a metadata module that processes the data entered by the end user and creates a medical narrative;
wherein the end user is able to edit and approve the medical narrative before it is authenticated.

19. The method of claim 18, wherein the metadata module includes a processor, at least one word processing module, at least one medical terminology module, and a narrative format module, the method further comprising:
utilizing the processor to do the following:
(a) use the word processor module to read and parse the data fields, wherein the word processor module uses the medical terminology module to provide medical terms and phrases;
(b) use the narrative format module to determine the narrative format that is best suited for the data; and
(c) automatically generate the medical narrative;
wherein processing the medical data entered, determining the narrative format and automatically generating the medical narrative all occur in real time.

20. The method of claim 19, wherein the medical narrative is displayed holographically.

21. The method of claim 20, wherein the interactive holographic display system includes a mic, a plurality of front facing cameras, the method further comprising:
authenticating the suggested medical narrative via at least one of the following: haptic control, gesture control, biometric data or voice commands.
